(19) United States
(12) Patent Application Publication
(10) Pub. No.: US 2013/0153357 A1
(43) Pub. Date: Jun. 20, 2013

(54) Series Damper For Single and Twin Friction Plate HD Clutch

(71) Applicants: Prashant Ashok Kulkarni, Fort Wayne, IN (US); Deevakar Kuppuswamy, Pune (IN)

(72) Inventors: Prashant Ashok Kulkarni, Fort Wayne, IN (US); Deevakar Kuppuswamy, Pune (IN)

(73) Assignee: Eaton Corporation, Cleveland, OH (US)

(21) Appl. No.: 13/600,615

(22) Filed: Aug. 31, 2012

Related U.S. Application Data
(60) Provisional application No. 61/570,788, filed on Dec. 14, 2011.

(51) Int. Cl. F16D 13/58

(52) U.S. Cl. 192/55.3

(57) ABSTRACT

A damper is provided which includes a primary damper and a secondary damper connected for series. The damper is utilized for damping torsional vibrations in a clutch assembly and is particularly useful for connecting reciprocating piston engines with a vehicle transmission.

### CROSS-REFERENCE TO RELATED APPLICATIONS

This application claims the benefit of U.S. Provisional Application No. 61/570,788, filed Dec. 14, 2011.

### FIELD OF THE INVENTION

The present invention relates to the field of torsional vibration dampers in general, and more specifically to friction clutches having torsional vibration dampers.

### BACKGROUND OF THE INVENTION

Torsional vibrations are the rotational irregularities of a rotating driven component. In a vehicle drivetrain, torsional vibrations are caused by forces generated within a combustion engine by the combustion of gases during the periodic combustion process. Torsional vibrations not only emanate from the engine power pulses but also from torque spikes and from abrupt changes in driveline torque due to rapid engine acceleration and deceleration. Examples of torsional dampers for dry friction clutches can be found by a review of commonly assigned U.S. Pat. No. 8,006,820 to Bassett and U.S. patent application Ser. No. 13/398,108, filed Feb. 16, 2012 to Franke, the disclosures of which are incorporated herein. It is desirable to provide a torsional damper that is especially applicable in a heavy duty application and that is an alternative to those afore described.

### SUMMARY OF THE INVENTION

To meet the aforementioned and other desires, a revelation of the present invention is brought forth. In a preferred embodiment, the damper of the present invention includes a primary damper which is connected in series with a secondary damper. By employing a series damper arrangement, the toque will flow through the dampers in series, enabling more effective engine vibration reduction than can be achieved with parallel arranged dampers. The damping that can be achieved with the present inventive damper is comparable to damping provided by a dual mass flywheel damping system, but at a significantly lower cost. The inventive damper of the present invention can have at least two damper portions with distinct spring rates and spring travels including at least one damper portion with a softer dampening rate than the effective damping rate of either a parallel damper assembly or a single damper assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective section view of a preferred embodiment damper according to the present invention shown in an environment of a dual plate clutch assembly;

FIG. 2 is a sectional view of the damper shown in FIG. 1;

FIG. 3 is an enlarged sectional view of a portion of the damper shown in FIG. 1;

FIG. 4 is an enlarged perspective sectional view of the damper shown in FIG. 1;

FIG. 5 is a perspective sectional view of the damper shown in FIG. 1;

FIG. 6 is a section perspective view of the damper shown in FIG. 1;

FIG. 7 is a perspective view of a friction disc utilized in the damper shown in FIG. 1;

FIG. 8 is an exploded view of an alternate preferred embodiment damper of the present invention;

FIG. 9A is an exploded perspective view of various components utilized in the damper shown in FIG. 8;

FIG. 9B is a perspective view of a component utilized in the damper shown in FIG. 8;

FIG. 10 is a partial enlarged sectional view of the damper shown in FIG. 8;

FIG. 11 is a view similar to that of FIG. 10 of another alternate preferred embodiment damper according to the present invention;

FIG. 12 is a perspective view of a component of the damper shown in FIG. 11;

FIG. 13 is a sectional view similar to that of FIG. 2 of yet another alternate preferred embodiment damper according to the present invention;

FIG. 14 is an exploded view of various components utilized in the damper shown in FIG. 13;

FIG. 15 is a view similar to that of FIG. 2 of yet another alternate preferred damper according to the present invention;

FIG. 16 is a perspective of a component utilized in a damper shown in FIG. 15; and

FIG. 17 is a section perspective view of another alternate preferred embodiment damper according to the present invention similar to the damper shown in FIGS. 13 and 14, but being different in that it has only one friction disc for utilization in a single plate clutch assembly.

### DETAILED DESCRIPTION OF THE PREFERRED EMBODIMENTS

The following description of the preferred embodiment(s) is merely exemplary in nature and is in no way intended to limit the invention, its application, or uses.

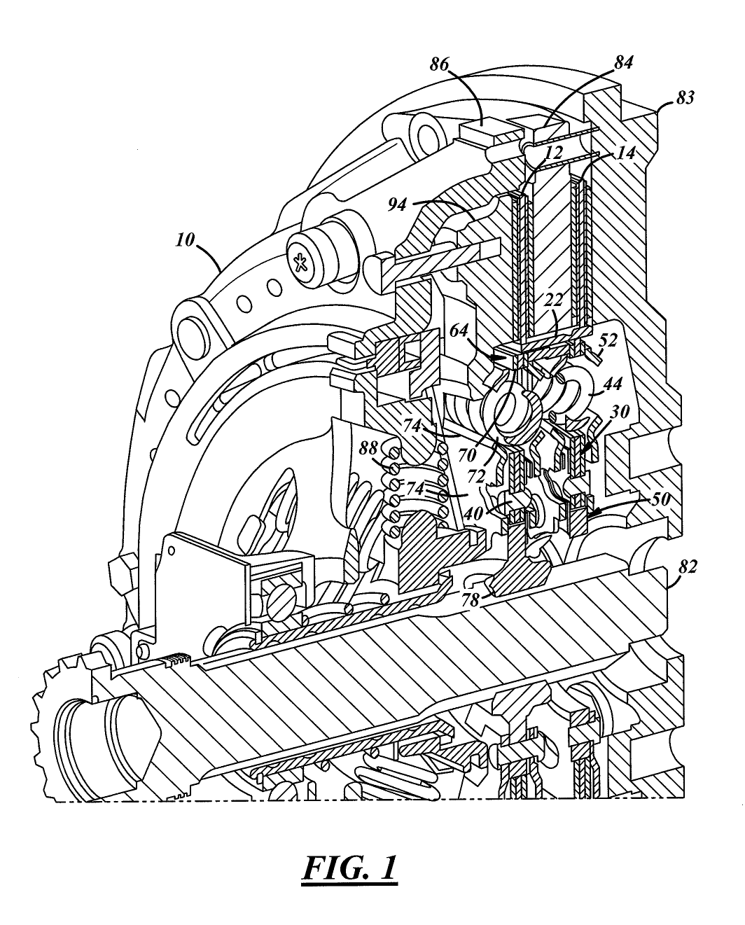

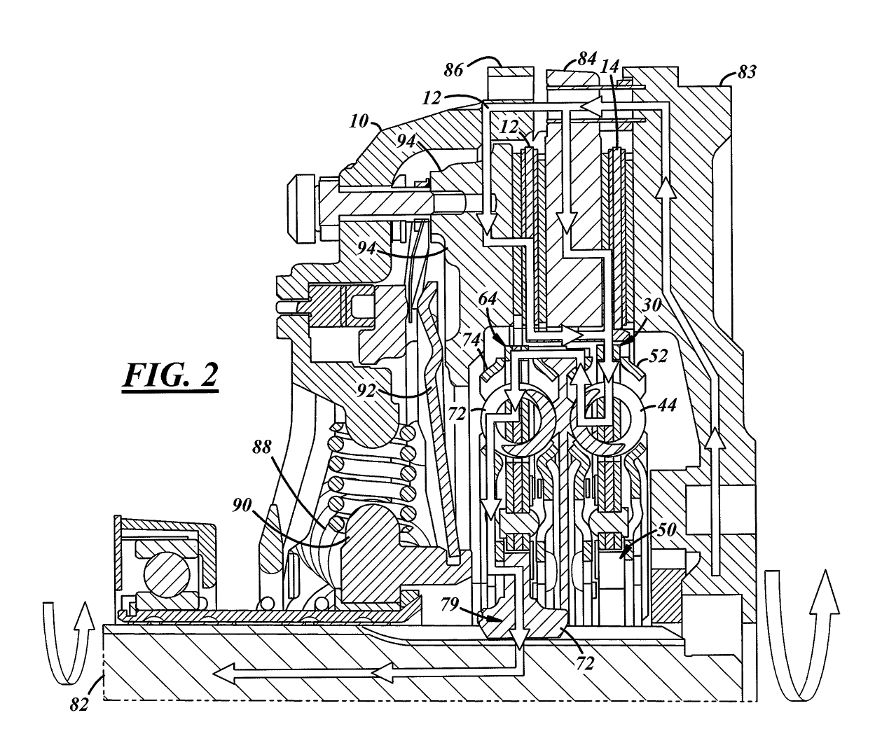

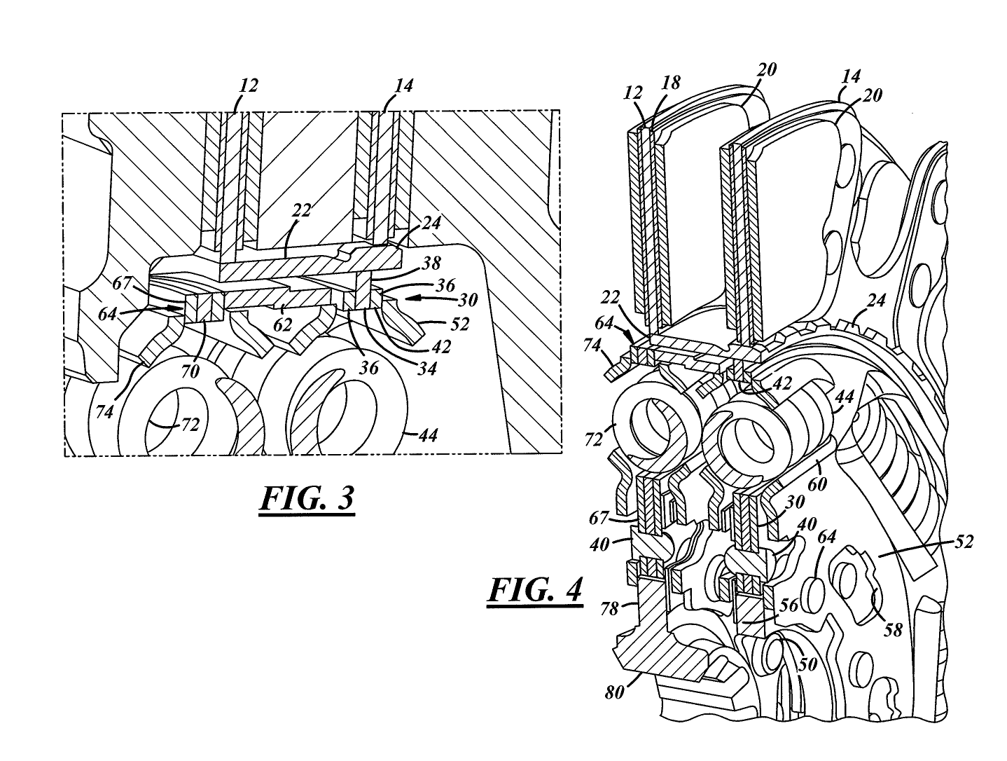

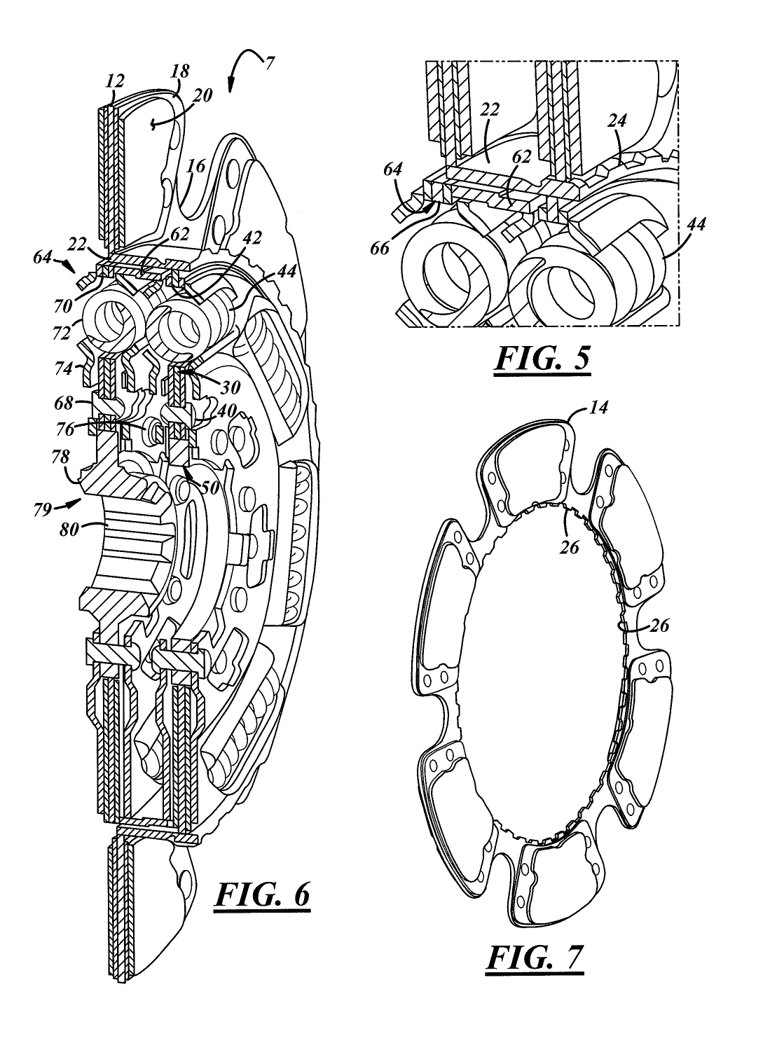

Referring to FIGS. 1-7, a preferred embodiment damper 7 is provided and is shown in FIGS. 1-3 in the environment of its accompanying dual friction plate clutch assembly 10. The damper 7 has torsionally connected thereto a first friction disc 12 and a second friction disc 14. The friction disc 12 is fabricated from a base plate 16 (FIG. 6). On opposing sides of the base plate 16 are rivet attached reinforcement plates 18 having friction pads 20 mounted thereon. The friction disc 12 has an inner peripheral edge torsionally connected by welding or by some type of geometric interlock with an outer drum 22. Opposite the friction disc 12 connection with the outer drum 22 the outer drum on its outer peripheral surface has a series of spline teeth 24 (FIG. 5). The spline teeth 24 allow the second friction disc 14 to be torsionally connected thereto and to also allow the second friction disc 14 to have relative axial movement with respect to the first friction disc 12 by virtue of its spline inner peripheral edge 26. The outer drum 22 along its inner diameter peripheral surface has a mechanically interlocking relationship with a first disc assembly 30. First disc assembly 30 has a center disc plate 34 (FIG. 3). The disc plate 34 is captured between two reinforcing plates 36. The disc plate 34 and reinforcing plates 36 can be similar to those described in previously mentioned co-assigned U.S. Pat. No. 8,066,820. The plates 36 and disc 34 are held together by a series of geometrically spaced rivets 40 forming the first disc assembly of the damper.

The first disc assembly 30 has a series of apertures 42. Positioned within this series of geometrically spaced apertures 42 are a first plurality of coil damping springs 44. The disc assembly 30 provides a drive element into the springs 44 in a manner similar to that described in aforementioned in U.S. Pat. No. 8,066,820.

Axially capturing first disc assembly 30 is a first hub assembly 50. The first hub assembly includes axially spaced apart spring cover plates 52. The spring cover plates 52 are connected by a series of rivets 54 with a hub rim 56. The spring cover plates 52 have a series of apertures 58 (FIG. 4) allowing space for the heads of the rivets 40. The spring cover plates 52 have a series of apertures 60 which mount the springs 44 and allow the first hub assembly 50 to be torsionally associated and driven through the springs 44 by the first disc assembly 30. The combination of the first disc assembly and the first hub assembly provide a primary damper.

Torsionally connected to the primary damper inboard spring cover plate 52 typically by a mechanical interlock is a connector ring or inner drum 62. The inner drum 62 on an end opposite the primary damper inboard spring cover plate is torsionally connected typically by a mechanical interlock with a second disc assembly 64 (FIG. 5). The second disc assembly 64 includes a disc plate 66 connected with lateral reinforcing plates 67 (FIG. 3) via rivets 68 (FIG. 6). The second disc assembly 64 is substantially similar to the first disc assembly 30 with the exception that it is torsionally connected with the inner drum 62 rather than with the outer drum 22. The aperture 70 of the second disc assembly 64 mounts a second plurality of springs 72. The second plurality of springs typically has a spring constant that is a greater, equal or lesser than the spring constants of the springs 44. The spring constant will be varied based on the driveline and damping requirements of a particular truck or user.

Capturing the springs 72 are two spring cover plates 74. The spring cover plates 74 are attached by a series of rivets 76 with a hub 78 to provide a second hub assembly 79. The hub 78 along its inner diameter has a series of spline teeth 80 torsionally connected with a transmission input shaft 82.

In operation, a flywheel 83 is torsionally connected with an crankshaft of an engine (not shown). The flywheel 83 is also torsionally connected with a clutch assembly cover 86. An intermediate plate 84 is torsionally connected by lugs (not shown) with the clutch assembly cover 86. The clutch cover 86 mounts a series of coil springs 88 which bias a spring retainer 90 to urge a lever 92 to push a pressure plate 94 towards friction disc 12 and 14 which are captured respectively between the pressure plate 94 and the intermediate plate 84 and the intermediate plate 84 and the flywheel 83. Therefore, torque is transferred from the flywheel 83 to the friction discs 12 and 14. Torque from the friction discs 12 and 14 is then thereafter transferred to the outer drum 22 and then to the first disc assembly 30. Torque from the first disc assembly 30 is transferred to the plurality of springs 44 and then into the first hub assembly 50. Torque is transferred from the first hub assembly 50 to the second disc assembly 64 via the inner drum 62. From the second disc assembly 64, torque is transferred through the second plurality of damping coil springs 72 into the second hub assembly 89 and thereafter through hub 78 through splined teeth 80 into the transmission shaft 2. An optional lower spring constant of the first plurality of damping springs 42 provides a “softer” damping which is typically advantageous of engines having their peak torque at lower revolution per minute (RPM) values.

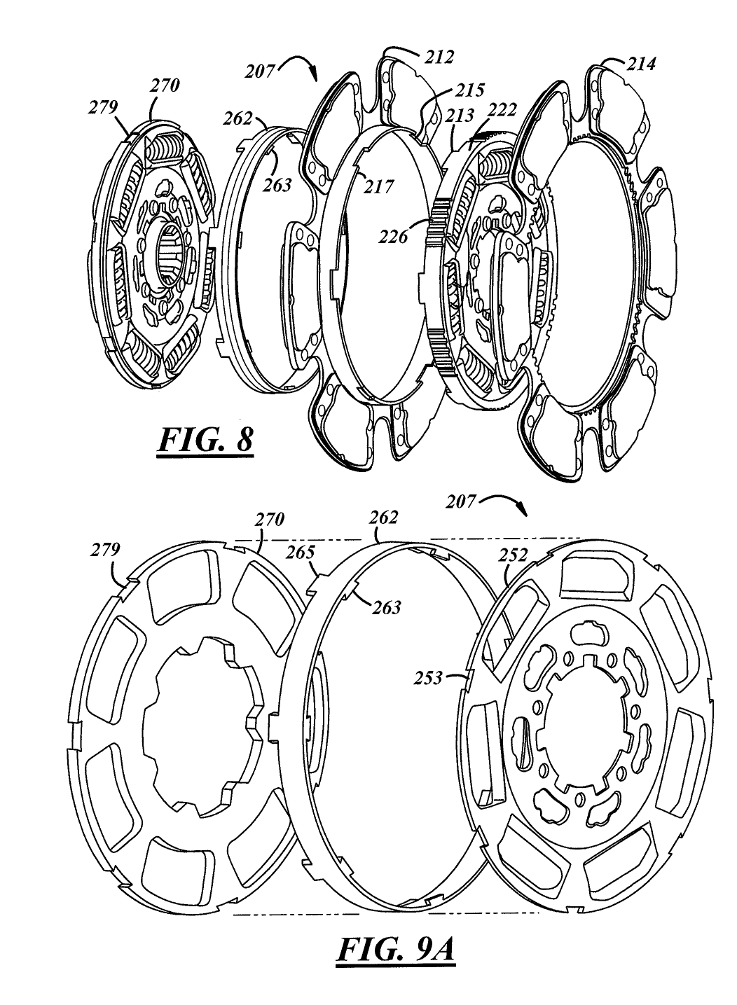

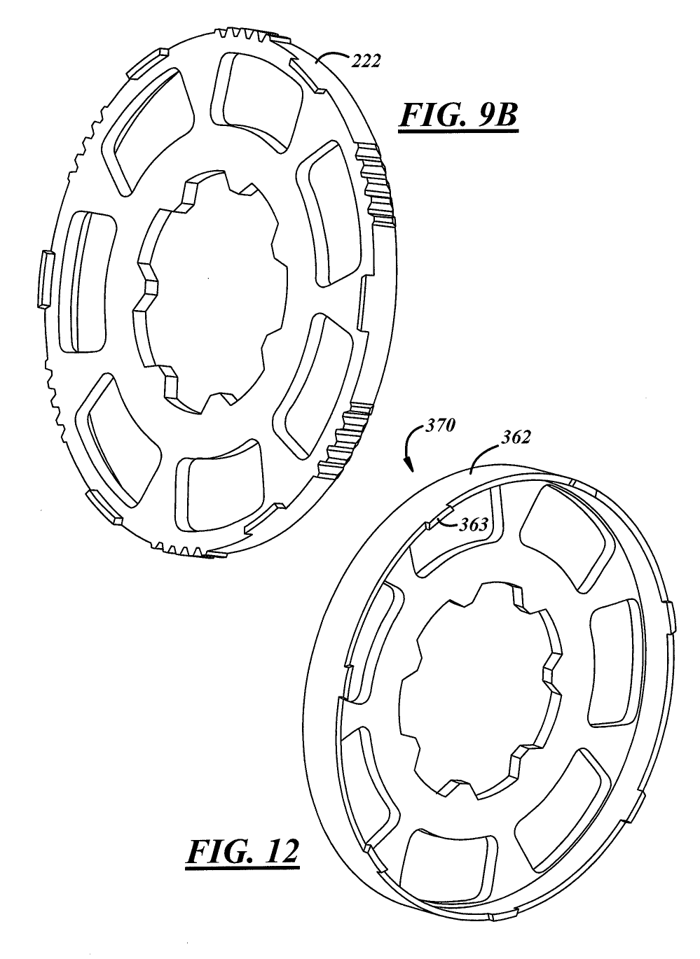

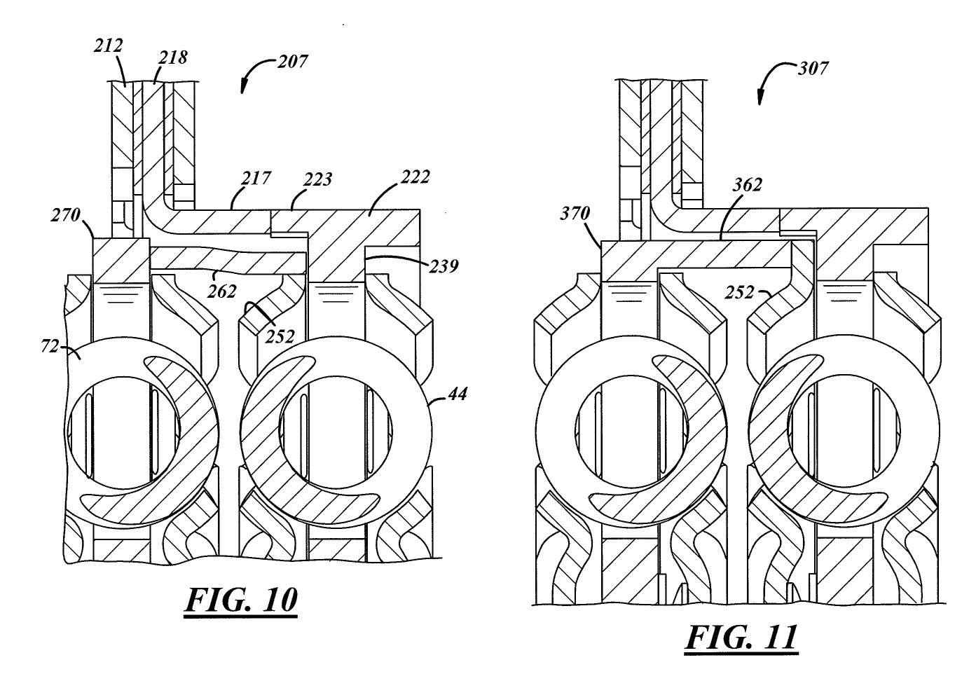

Referring to FIGS. 8-10, an alternate preferred embodiment damper 207 according to the present invention is provided. The damper 207 is similar to damper 7 as previously described with certain modifications. A first friction disc 212 has a metallic plate 218 with an “L” shape bend. This “L” shaped bend forms a tubular section 217 with rectangular cutouts 215. A single piece first plate assembly 222 is provided. The first plate assembly 222 in combination with the tubular portion 217 of the friction plate assembly interlock by having a tab 213 of the first disc assembly 222 interlocked within the cutouts 215 of the first friction plate. In other embodiments (not shown), other means of mechanical, weld or other means of connection may be utilized. The first disc assembly 222 has a “T” shaped cross-section with a portion 223 which in combination with the tubular portion 217 of the first friction plate form a part equivalent to the previously described outer drum 22 of damper 7. A connector ring or drum 262 torsionally connects the inboard spring plate cover 252 with the second disc assembly 270. The inner drum 262 has a series of radially inward projecting dove tail projectors 263 to interlock within dove tail slots 253 of the inner spring cover plate 252. The inner drum 262 has a series of axially extending rectangular tab 265 for projection within dove tail slots 279 of the second disc assembly 270. In other embodiments (not shown), other means of mechanical, weld or other means of connection may be utilized. With this configuration, the torsional connection of the first hub assembly to the second disc assembly are both radially outward of the first and second plurality of damping springs 44 and 72.

Referring to FIGS. 11 and 12, an alternate preferred embodiment damper 307 according to the present invention is substantially similar to that afore described damper 207 wherein the inner torsional connective drum 362 (single stack drum) is provided and is integral with the second disc assembly 370. The torsional connection between the second disc assembly 370 with the inboard spring cover plate 252 is slightly different in that the second disc assembly has axially extending tabs 363 for connection with the tabs 253 of the afore described spring cover plate 252. The torsional interface between the drum portion 362 and the inboard spring cover plate 252 provides a radial interface versus the axially extending interface between the drum 262 and the inboard spring plate of the damper 207. In other embodiments (not shown), other means of mechanical, weld or other means of connection may be utilized.

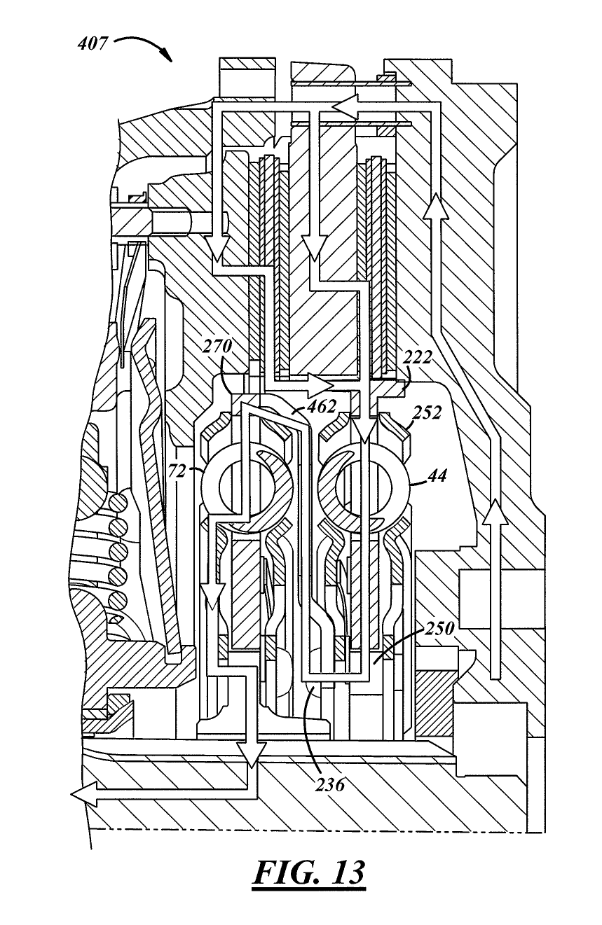

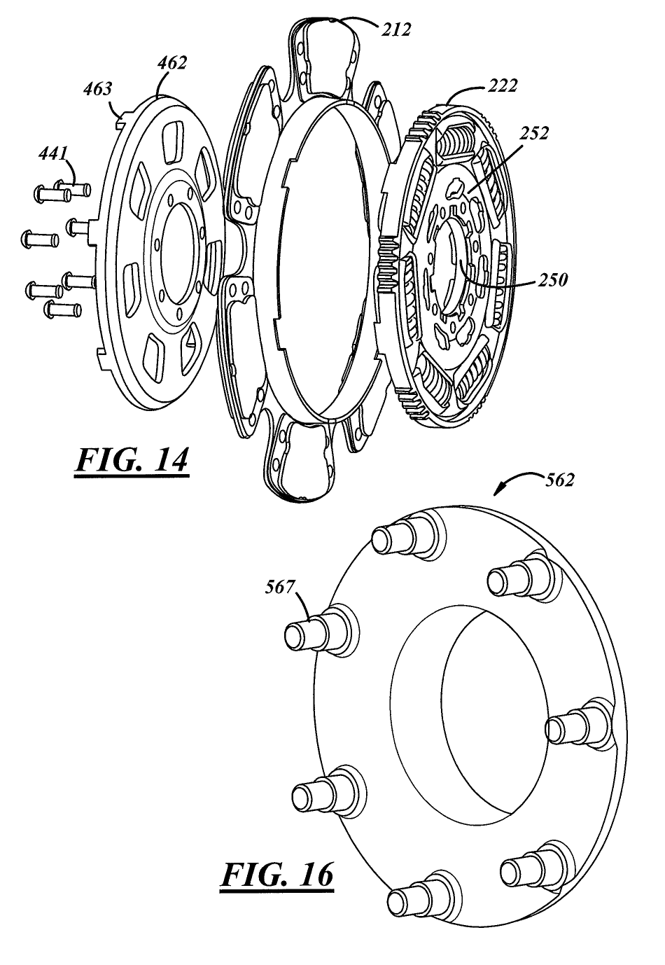

Referring to FIGS. 13 and 14, an alternate preferred embodiment damper 407 is provided which functions essentially identically as the previously described dampers. Damper 407 differs from prior described damper in that it has a connector plate 462 which has a series of rivets 441 connecting it with the first hub assembly 250 and makes its connection with the first hub assembly at a location radially inward from the first and second pluralities of damping springs 44 and 72. In other embodiments (not shown), other means of mechanical, weld or other means of connection may be utilized. The connector plate 462 has a series of axially extending tabs 463 which extends into dove tail slots 279 as previously described for the second disc assembly 277 of the secondary damper. In other embodiments (not shown), other means of mechanical, weld or other means of connection may be utilized. The torsional connection with the secondary damper is radially outward of the first damping springs 44 and second damping springs 72. Therefore, torsional transfer from the hub extends through the connecting plate and does not extend through the inboard spring cover plate as do the previously described embodiments. This lessens the chance of distortion of the spring cover plate and also provides the advantage of higher torque capacity by fully utilizing the primary function of the spring covers to share the torque and transfer that to the connecting plate which can transfer a higher range of torque without damaging the spring cover.

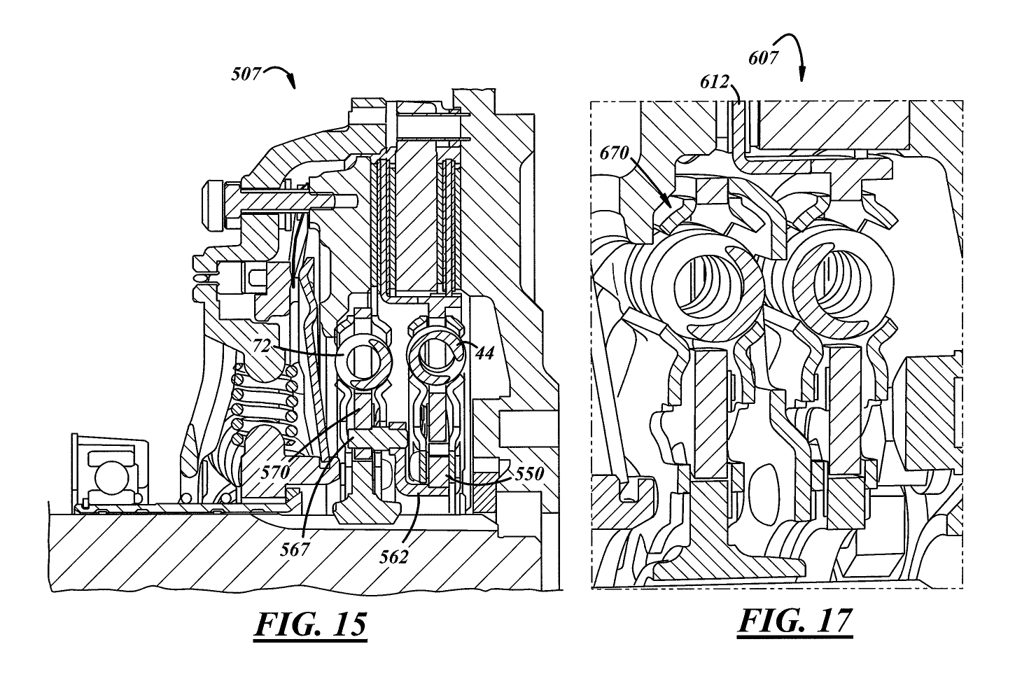

Referring to FIGS. 15 and 16, an alternate preferred embodiment damper 507 of the present invention is provided. The damper 507 is similar to those previously described with the main exception in that the connective member 562 is torsionally connected to the first hub assembly 550 via mechanical interlock or a tooth interface. The connection to the first hub assembly is radially inward the first plurality of springs 44. The connective member 562 by a series of studs 567 is connected with the second disc assembly 570 radially inward of the second plurality of damping springs 72.

Referring to FIG. 17, an alternate preferred damper according to the present invention 607 is provided. Damper 607 is substantially similar to damper 407 previously described with the exception that there is only one friction disc 612. This is for clutch assemblies without an intermediate plate. The friction disc extends over an area which is axially most closely adjacent the secondary damper 670.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A torsional damper comprising:
a first disc assembly;
a first hub assembly torsionally associated with said first disc assembly via a plurality of springs;
a second disc assembly having a torsional connection with said first hub assembly; and
a second hub assembly torsionally associated with said second disc assembly via a second plurality of springs.

2. A damper as described in claim 1 having two friction discs having a torsional connection with said first disc assembly.

3. A damper as described in claim 2 wherein one of said friction discs is joined to a drum and an outer periphery of said drum has a spline connection to allow said other friction disc to move axially with respect to said one friction disc.

4. A damper as described in claim 1 further having a friction disc which is axially closer to said second hub assembly than said first hub assembly.

5. A damper as described in claim 1 wherein said torsional connection between said first hub assembly and said second disc assembly is radially outward from said first and second pluralities of springs.

6. A damper as described in claim 5 wherein said torsional connection between said first hub assembly and second disc assembly is integral with said second disc assembly.

7. A damper as described in claim 5 having a separate drum connecting said second disc assembly to said first drum assembly.

8. A damper as described in claim 1 wherein said torsional connection between said first drum assembly to said second disc assembly is radially inward of said springs in its connection to said first drum assembly and is radially outward of said springs in its connection to the second disc assembly.

9. A damper assembly as described in claim 1 wherein said torsional connection between said first hub assembly to said second disc assembly is radially inward of said first and second plurality of springs.

10. A damper as described in claim 1 wherein said first hub assembly includes spring cover plates.

11. A damper assembly as described in claim 1 wherein said second hub assembly includes spring cover plates.

12. A disc assembly as described in claim 1 wherein said first disc assembly includes reinforcement plates.

13. A damper assembly as described in claim 1 wherein said first disc assembly has a portion thicker than a friction disc and has an integral drum portion spline connected to one of two friction discs.

14. A damper as described in claim 13 wherein said drum portion has a cross-section “T” shape and wherein one of the friction discs has an “L” shape section interlocked with said first disc assembly drum portion.

15. A damper as described in claim 1 wherein said first and second plurality of springs have differing spring rates.

16. A damper as described in claim 15 wherein said first plurality of springs have a spring constant less than said second plurality of springs.

17. A torsional damper comprising:
a first disc assembly, said first disc assembly having a generally “T” shaped cross-section with one arm of said “T” interlocked with a first “L” shaped friction disc and an outer radial surface of said “T” splined for connection with a second friction disc axially spaced from said first friction disc;
a first hub assembly torsionally associated with said first disc assembly via a plurality of springs having a first spring constant, said second hub assembly including parallel spaced spring cover plates;
a second disc assembly having a torsional connection with said first hub assembly; and
a second hub assembly torsionally associated with said second disc assembly via a second plurality of springs, said second plurality of springs having a spring constant greater than said spring constant of said first plurality of springs, said second hub assembly including parallel spaced spring cover plates.

18. A damper assembly as described in claim 17 wherein said second disc assembly is interlocked to said first hub assembly by a single stack drum plate interlocked with one of said spring cover plates of said first hub assembly and wherein said drum in integral with said second disc assembly.

19. A damper as described in claim 17 wherein a plate connected radially inward of said first plurality of springs with said first hub assembly is connected with said second disc assembly radially outward of said second plurality of springs.

20. A damper as described in claim 17 having a connector bowl connected with said first hub assembly radially inward said first plurality of springs and connected with said second disc assembly radially inward of said second plurality of springs.

21. A selectively engagable dry friction clutch assembly for selectively torsionally connecting a transmission input shaft with a flywheel of an engine comprising:
a clutch cover having a main body axially separated from said flywheel and being torsionally connected thereto;
an axially removable pressure plate torsionally connected with said clutch cover;
a friction disc for having torsional connection with an input shaft of a transmission, said friction disc being axially positioned between said flywheel and said pressure plate;
a release assembly for releasing said pressure plate from an axially biased position connecting said friction plate with said flywheel;
a first disc assembly torsionally connected with said friction disc;
a first hub assembly torsionally associated with said first disc assembly via a first plurality of springs;
a second disc assembly having a torsional connection with said first hub assembly; and
a second hub assembly torsionally associated with said second disc assembly via a second plurality of springs, and said second hub assembly being torsionally connected with said transmission input shaft.
